(19) United States
(12) Patent Application Publication
(10) Pub. No.: US 2024/0231866 A9
(43) Pub. Date: Jul. 11, 2024

(54) Multi-Layer Kernel with Varied Privilege

(71) Applicant: Microsoft Technology Licensing, LLC, Redmond, WA (US)

(72) Inventors: Gangadhara Swamy SHIVAGANGA NAGARAJU, Kirkland, WA (US); Pushkar Vijay CHITNIS, Bothell, WA (US); Weidong CUI, Redmond, WA (US); Ziqiao ZHOU, Bellevue, WA (US)

(21) Appl. No.: 17/970,858

(22) Filed: Oct. 21, 2022

(51) Int. Cl. G06F 9/455

(52) U.S. Cl. CPC G06F 9/45558; G06F 2009/45583; G06F 2009/45587

(57) ABSTRACT

A computer implemented method includes loading a first kernel layer having a first privilege level onto a hosting environment. A second kernel layer having a second privilege level different from the first privilege level is also loaded onto the hosting environment. The first kernel layer is isolated from the second kernel layer and access to a hosting environment memory protection table is controlled via the first kernel layer.

### BACKGROUND

A hosting environment provides hardware and deployment services for creating and executing virtual machines. The deployment services may be provided by software to both create and run virtual machines. Such software may be referred to as a hypervisor that enables multiple virtual machines to run on the hardware and to share resources, like memory and processing resources.

The virtual machines may include firmware, which is code used to interface an operating system to the hardware. The firmware may be modified for different hardware platforms and may be updated from time to time. Apps may be loaded on top of the operating system to provide desired services to a user.

Some users today would like their virtual machines to be confidential. Users also have concerns about vulnerabilities in the hosting environment that make up the dependencies for virtual machines to launch. Some hosting environments provide trusted platform modules in default firmware that can be used to encrypt data in memory, data that is stored, or both. Such encryption can help assure users that the virtual machines and the data they process are held in confidence. However, the user may not trust the software dependencies in the hosting environment.

### SUMMARY

A computer implemented method includes loading a first kernel layer having a first privilege level onto a hosting environment. A second kernel layer having a second privilege level different from the first privilege level is also loaded onto the hosting environment. The first kernel layer is isolated from the second kernel layer and access to a hosting environment memory protection table is controlled via the first kernel layer.

### BRIEF DESCRIPTION OF THE DRAWINGS

FIG. 1 is a block diagram of a system for hosting virtual machines with multi-layer firmware having different privilege levels according to an example embodiment.

FIG. 2 is a flowchart illustrating a computer implemented method of using separate firmware kernel layers with different privilege levels in a hosting environment according to an example embodiment.

FIG. 3 is a block diagram of multistate boot flow in a confidential virtual machine deployment having kernel firmware with different privilege levels according to an example embodiment.

FIG. 4 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Despite the recent exponential growth of businesses using cloud based services, businesses that handle sensitive data, such as those in the financial and health sectors, are hesitant to migrate their on-premises TT (information technology) infrastructure to the public cloud due to the lack of the trust of the cloud provider. Cloud service providers are attempting to remove themselves from a trusted computing base (TCB) to enable these businesses to migrate their on-premises workloads to the cloud. Such removal achieves the security goal by creating a hardware-based trusted execution environment (TEE) that is encrypted and isolated from the rest of the software stack managed by the cloud provider.

In particular, the recently launched 3rd-generation AMD EPYC CPUs are capable of running a full virtual machine (NM) inside a TEE and protecting its confidentiality and integrity against a potentially malicious hypervisor owned by an untrusted cloud provider.

While a confidential VM is a promising primitive to host sensitive on-premises workloads, it has major limitations. A confidential VM does not provide the VM-level backward compatibility. It requires non-trivial changes in the guest OS kernel to accommodate architectural differences and run securely in the new environment. For example, the guest OS in a confidential VM has to manage the state of its physical address space (e.g., private pages for security-sensitive computation and shared pages for I/O), and it also has to be implemented defensively whenever interacting with the untrusted hypervisor (e.g., hypervisor-injected interrupts).

In one example of the present inventive subject matter, first and second independent firmware kernel layers having different privilege levels are loaded onto the hosting environment. The first kernel layer has a higher privilege level, is isolated from the second kernel layer firmware, and exclusively controls access to host environment memory and storage via a hosting environment memory protection table.

The use of two independent firmware kernel layers provides one or more benefits over prior solutions where multiple kernels in the virtual machine may be layered such that the lower privilege level kernel needs to rely completely and solely on abstractions offered by higher privilege level for their interactions with hypervisor. One potential benefit is that there is no performance overhead of using the higher privilege level kernel as it is brought into play only when the lower privilege level kernel has a need for some special trusted service or device.

Both kernels can independently interact with the hypervisor. But since the higher privilege level kernel is isolated from the lower privilege kernel, it can offer trusted devices or services which the lower privilege level kernel can't tamper with. In confidential virtual machines, this is especially useful since the higher privilege level kernel can offer virtual machine virtualized devices and services which are isolated and protected against both the lower privilege level kernel as well as hosting environment such as the hypervisor.

This approach also eliminates the need to have a UEFI in the boot order. Any services offered by the UM can be replaced by the higher-level Linux Kernel. This also reduces the attack surface for the VM by removing the UEFI surface completely.

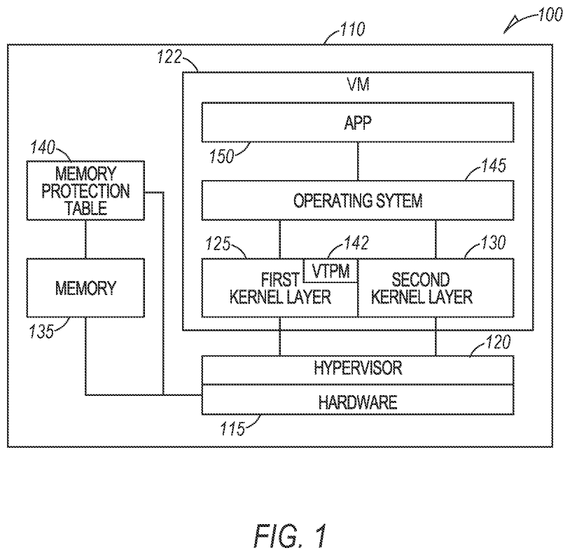

FIG. 1 is a block diagram of a system 100 for hosting virtual machines with multi-layer firmware having different privilege levels according to an example embodiment. System 100 may include a host environment 110 for providing computing resources for the creation and execution of virtual machines for users. Host environment 110 includes hardware 115, such as one or more processors from one or more different processor suppliers. A hypervisor 120 may be used to provision and manage one or more virtual machines, such as virtual machine 122, which may be a confidential virtual machine.

Firmware in the form of a first kernel layer 125 and a second kernel layer 130 may be loaded onto the host system 110 for execution on the hardware 115 via the hypervisor 1:20, The firmware layers may be independent of each other and in one example may be Linux® kernels. In one example, the first kernel layer 125 has a higher level of privilege than the second kernel layer 130, The first kernel layer 125 may have exclusive access to hardware-based memory controls for controlling access to a memory 135 via use of a memory protection table 140. In one example, an AMD SEV0SNP VMPL CPU provides such controls.

Memory 135 may include random access memory or other data storage devices. By controlling memory access, the first kernel layer 125 may be isolated from other components of system 100, enabling the provision of trusted devices that can only be accessed by the first kernel layer 125. The first kernel layer 125 may provide such trusted services to the second kernel layer 130 which runs at a lower privilege level.

Confidentiality of the virtual machine 122 may be provided by one such trusted device, virtual trusted platform module (vTPM) 142 which may be used to encrypt information that is stored and accessible to the virtual machine 122. Further examples of a trusted device or service, also represented by block 122, include virtual runtime measurement registers (vRTMRs) and policy controlled serial console.

Virtual machine 122 may include an operating system 145 that interfaces to the first and second kernel layers 125, 130, and one or more applications 150 that run on the operating system 145. The vTPM 142 provides encryption services. The first kernel layer 125 also controls access to memory for the hypervisor 120, operating system 145, and applications 150.

In one example, first kernel layer 125 is auditable by the user via a hash of the first kernel layer 125. Any changes to the firmware will result in the hash changing, indicating that the first kernel layer 1:25 has been changed. The first kernel layer 125 firmware is thus auditable to ensure no changes have been made.

In one example, the firmware and associated build tools may be open sourced with reproducible builds to allow customers to audit their firmware. Since the firmware has no direct service dependencies, no other component/service needs to be audited to trust the firmware. A trusted confidential virtual machine (CVM) stack and configuration may be reflected within the CPU report.

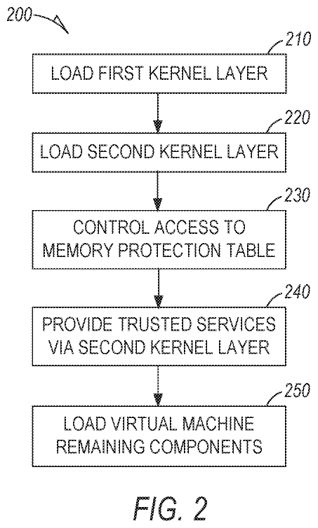

FIG. 2 is a flowchart illustrating a computer implemented method 200 of using separate firmware kernel layers with different privilege levels in a hosting environment. Method 200 begins at operation 210 by first loading a first kernel layer having the higher privilege level onto a hosting environment. A second kernel layer having a second privilege level lower than the first privilege layer is loaded onto the hosting environment at operation 220 such that the first kernel layer is isolated from the second kernel layer. Isolation includes memory isolation and contact with specific CPU functions.

Access to a hosting environment memory protection table is controlled at operation 230 via the first kernel layer. Controlling access to a hosting environment memory protection table via the first kernel layer provides hardware-based memory isolation to limit memory access to the second kernel layer, a hypervisor on which the first and second kernel are executing, and to a virtual machine loaded onto the hosting environment. The first kernel layer has exclusive control over modifications, to the memory protection table.

The memory protection table is used by the higher privilege layer which only it can access and helps prevent other layers from accessing memory areas for which they are not authorized. The ability to protect memory by the first kernel layer is provided by the hardware and enables the first kernel layer to be the only entity that can change the memory protection table. The two kernels are loaded into two separate privilege levels supported by the hardware to enforce separation of the kernels as well as the virtual machine.

The first kernel layer provides trusted services at operation 240 via the first kernel layer and restricts access to hosting environment memory via the memory protection table. The first kernel layer provides the trusted services to the second kernel layer in one example. The second kernel layer may have independent input and output.

The first and second kernel layers are loaded onto a hypervisor and each can interact directly with the hypervisor. The first and second kernel layers may be loaded in memory alongside each other or sequentially. Method 200 may continue at operation 250 by loading remaining virtual machine components for a customer onto the hosting environment such that the first kernel layer enables the virtual machine to be a confidential virtual machine. The first kernel layer is auditable by the customer to ensure the first kernel layer is unchanged via a hash of the first kernel layer. A hash generated by any suitable hash generator on the first kernel layer may be used to provide identity and integrity when the original hash matches a new hash.

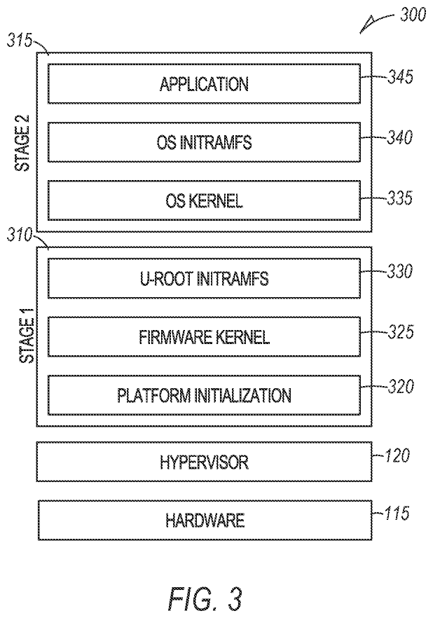

FIG. 3 is a block diagram of multistate boot flow 300 using for example, Linuxboot, in a confidential virtual machine deployment having kernel firmware with different privilege levels.

Two boot stages, a first stage 310 and a second stage 315 are shown. The first stage 310 is for hooting the firmware and includes platform initialization at 320, firmware kernel loading at 325, and U-root initiation at 330. The firmware, comprising first kernel layer 125 and second kernel layer 130 may be booted alongside each other or sequentially. In either case, the first kernel layer 125 will be executed first. If loaded sequentially, first kernel layer 125 cart extend attestation measurements of the second kernel layer 130 during loading.

Hypervisor 120 initializes user memory layout and CPU state during platform initialization at 320. The memory layout may contain firmware kernel and initramfs (initial root file system). Pages and measures are locked. Measurements can be reflected in hardware attestation reports.

Firmware kernel loading 325 includes loading the kernel with minimal device support. The kernel loads initramfs CPIO (a copy in and out Unix utility) to form an initial root file system and executes init 330. U-root Initramfs are booted by executing U-root init. Init fetches the hardware report and verifies configuration meta data. Stage 2 kernel and initramfs are also verified. A primitive may be called to allow loading of the kernel in a different privilege level. KEXEC is one example primitive that allows loading of a kernel in a different privilege level.

Stage 2 includes loading operating system Kernel 335, operating system initramfs 340 and application 345. Using Linuxboot for confidential virtual machine deployments for customer managed, user-controlled firmware flows have several benefits including auditability where all linux devs are firmware auditors. Drivers may be the same within the operating system and firmware. Safety and performance benefits include the use of hard, a temporary root file system used during boot which is written in “go” which provides memory safety and parallelization.

The first kernel layer 125 may be kept small in one example, with minimum functionality. If virtual machine attestation is available, the first kernel layer 125 may be directly measured. Having separate and independent kernel layers allows separate management of the kernel layers. The kernel layers may be configured to eliminate any dependencies during updates, although there can be runtime functional dependencies. The separate kernels can be updated independently.

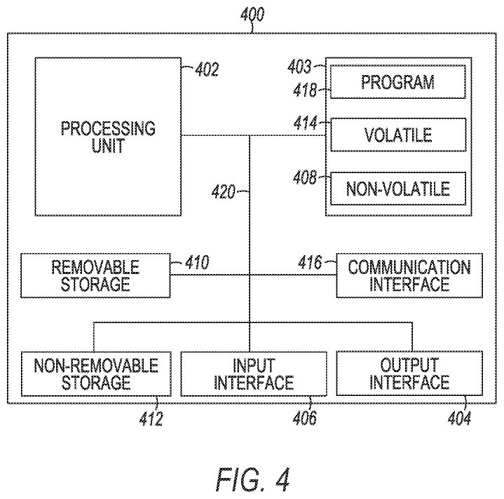

FIG. 4 is a block schematic diagram of a computer system 400 to provide a hosting environment having two firmware kernel layers with different privilege levels and for performing methods and algorithms according to example embodiments. All components need not be used in various embodiments.

One example computing device in the form of a computer 400 may include a processing unit 402, memory 403, removable storage 410, and non-removable storage 412. Although the example computing device is illustrated and described as computer 400, the computing device may be in different forms in different embodiments. For example, the computing device may instead be a smartphone, a tablet, smartwatch, smart storage device (SSD), or other computing device including the same or similar elements as illustrated and described with regard to FIG. 4. Devices, such as smartphones, tablets, and smartwatches, are generally collectively referred to as mobile devices or user equipment.

Although the various data storage elements are illustrated as part of the computer 400, the storage may also or alternatively include cloud-based storage accessible via a network, such as the Internet or server-based storage. Note also that an SSD may include a processor on which the parser may be run, allowing transfer of parsed, filtered data through 110 channels between the SSD and main memory.

Memory 403 may include volatile memory 414 and non-volatile memory 408. Computer 400 may include—or have access to a computing environment that includes—a variety of computer-readable media, such as volatile memory 414 and non-volatile memory 408, removable storage 410 and non-removable storage 412. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 400 may include or have access to a computing environment that includes input interface 406, output interface 404, and a communication interface 416. Output interface 404 may include a display device, such as a touchscreen, that also may serve as an input device. The input interface 406 may include one or more of a touchscreen, touchpad, mouse, keyboard, camera, one or more device-specific buttons, one or more sensors integrated within or coupled via wired or wireless data connections to the computer 400, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (VS/AN), Bluetooth, or other networks. According to one embodiment, the various components of computer 400 are connected with a system bus 420.

Computer-readable instructions stored on a computer-readable medium are executable by the processing unit 402 of the computer 400, such as a program 418. The program 418 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 418 along with the workspace manager 422 may be used to cause processing unit 402 to perform one or more methods or algorithms described herein.

### EXAMPLES

1. A computer implemented method includes loading a first kernel layer having a first privilege level onto a hosting environment. A second kernel layer having a second privilege level different from the first privilege level is also loaded onto the hosting environment. The first kernel layer is isolated from the second kernel layer and access to a hosting environment memory protection table is controlled via the first kernel layer.

2. The method of example 1 wherein the first kernel layer provides trusted services and restricts access to hosting environment memory via the memory protection table.

3. The method of example 2 wherein the first kernel layer provides the trusted services to the second kernel layer.

4. The method of any of examples 1-3 wherein the second kernel layer has independent input and output.

5. The method of any of examples 1˜4 wherein the first and second kernel layers are loaded in memory sequentially.

6. The method of any of examples 1-5 wherein the first and second kernel layers are loaded onto a hypervisor and each can interact directly with the hypervisor.

7. The method of any of examples 1-6 and further including loading a virtual machine for a customer onto the hosting environment such that the first kernel layer enables the virtual machine to be a confidential virtual machine.

8. The method of example 7 wherein the first kernel layer is auditable by the customer to ensure the first kernel layer is unchanged via a hash of the first kernel layer.

9. The method of any of examples 1-8 wherein controlling access to a hosting environment memory protection table via the first kernel layer provides hardware-based memory isolation to limit memory access to the second kernel layer, to a hypervisor on which the first and second kernel are executing, and to a virtual machine loaded onto the hosting environment.

10. The method of example 9 wherein the first kernel layer has exclusive control over modifications to the memory protection table.

11. The method of any of examples 1-10 wherein the first and second kernels are open source kernels.

12. A device includes a hardware processor and a memory device accessible by the hardware processor. The memory device includes a hypervisor for execution on the hardware processor, a first kernel layer, having a first privilege level, for execution by the hardware processor, and a second kernel layer, having a second privilege level different from the first privilege layer, for execution by the hardware processor such that the first kernel layer is isolated from the second kernel layer and the first kernel layer is configured to control access to a hosting environment memory protection table.

13. The device of example 12 wherein the first kernel layer provides trusted services, restricts access to hosting environment memory via the memory protection table, and provides the trusted services to the second kernel layer.

14. The device of any of examples 1243 wherein the first and second kernel layers are loaded in memory sequentially onto a hypervisor and each can interact directly with the hypervisor.

15. The device of any of examples 12-14 wherein the memory device includes a virtual machine for a customer such that the first kernel layer enables the virtual machine to be a confidential virtual machine.

16. The device of example 15 wherein the first kernel layer is auditable by the customer to ensure the first kernel layer is unchanged via a hash of the first kernel layer.

17. The device of any of examples 12-16 wherein the first kernel layer controls access to a hosting environment memory protection table to provide hardware-based memory isolation to limit memory access to the second kernel layer, to a hypervisor on which the first and second kernel are executing, and to a virtual machine loaded onto the hosting environment.

18. A machine-readable storage device has instructions for execution by a processor of a machine to cause the processor to perform operations to perform a method. The operations include loading a first kernel layer having a first privilege level onto a hosting environment, loading a second kernel layer having a second privilege level different from the first privilege level onto the hosting environment such that the first kernel layer is isolated from the second kernel layer, and controlling access to a hosting environment memory protection table via the first kernel layer.

19. The device of example 18 wherein the first kernel layer provides trusted services, restricts access to hosting environment memory via the memory protection table, and provides the trusted services to the second kernel layer.

20. The device of any of examples 18-19 wherein the operations further include loading a virtual machine for a customer onto the hosting environment such that the first kernel layer enables the virtual machine to be a confidential virtual machine.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
loading a first kernel layer having a first privilege level into a hosting environment;
loading a second kernel layer having a second privilege level different from the first privilege level onto the hosting environment such that the first kernel layer is isolated from the second kernel layer; and
controlling access to a hosting environment memory protection table via the first kernel layer.

2. The method of claim 1 wherein the first kernel layer provides trusted services and restricts access to hosting environment memory via the memory protection table.

3. The method of claim 2 wherein the first kernel layer provides the trusted services to the second kernel layer.

4. The method of claim 1 wherein the second kernel layer has independent input and output.

5. The method of claim 1 wherein the first and second kernel layers are loaded in memory sequentially.

6. The method of claim 1 wherein the first and second kernel layers are loaded onto a hypervisor and each can interact directly with the hypervisor.

7. The method of claim 1 and further comprising:
loading a virtual machine for a customer onto the hosting environment such that the first kernel layer enables the virtual machine to be a confidential virtual machine.

8. The method of claim 7 wherein the first kernel layer is auditable by the customer to ensure the first kernel layer is unchanged via a hash of the first kernel layer.

9. The method of claim 1 wherein controlling access to a hosting environment memory protection table via the first kernel layer provides hardware-based memory isolation to limit memory access to the second kernel layer, to a hypervisor on which the first and second kernel are executing, and to a virtual machine loaded onto the hosting environment.

10. The method of claim 9 wherein the first kernel layer has exclusive control over modifications to the memory protection table.

11. The method of claim 1 wherein the first and second kernels are open source kernels.

12. A device comprising:
a hardware processor; and
a memory device accessible by the hardware processor, the memory device including:
a hypervisor for execution on the hardware processor;
a first kernel layer, having a first privilege level, for execution by the hardware processor; and
a second kernel layer, having a second privilege level different from the first privilege layer, for execution by the hardware processor such that the first kernel layer is isolated from the second kernel layer and the first kernel layer is configured to control access to a hosting environment memory protection table.

13. The device of claim 12 wherein the first kernel layer provides trusted services, restricts access to hosting environment memory via the memory protection table, and provides the trusted services to the second kernel layer.

14. The device of claim 12 wherein the first and second kernel layers are loaded in memory sequentially onto a hypervisor and each can interact directly with the hypervisor.

15. The device of claim 12 wherein the memory device includes a virtual machine for a customer such that the first kernel layer enables the virtual machine to be a confidential virtual machine.

16. The device of claim 15 wherein the first kernel layer is auditable by the customer to ensure the first kernel layer is unchanged via a hash of the first kernel layer.

17. The device of claim 12 wherein the first kernel layer controls access to a hosting environment memory protection table to provide hardware-based memory isolation to limit memory access to the second kernel layer, to a hypervisor on which the first and second kernel are executing, and to a virtual machine loaded onto the hosting environment.

18. A machine-readable storage device having instructions for execution by a processor of a machine to cause the processor to perform operations to perform a method, the operations comprising:
loading a first kernel layer having a first privilege level onto a hosting environment;
loading a second kernel layer having a second privilege level different from the first privilege level onto the hosting environment such that the first kernel layer is isolated from the second kernel layer; and
controlling access to a hosting environment memory protection table via the first kernel layer.

19. The device of claim 18 wherein the first kernel layer provides trusted services, restricts access to hosting environment memory via the memory protection table, and provides the trusted services to the second kernel layer.

20. The device of claim 18 wherein the operations further comprise:
loading a virtual machine for a customer onto the hosting environment such that the first kernel layer enables the virtual machine to be a confidential virtual machine.
